(19) United States
(12) Patent Application Publication
(10) Pub. No.: US 2024/0400001 A1
(43) Pub. Date: Dec. 5, 2024

(54) WINDSHIELD WIPER BLADE ASSEMBLY

(71) Applicant: ALBEREE PRODUCTS, INC., Halethorpe, MD (US)

(72) Inventors: Albert LEE, Baltimore, MD (US); Franz J. BUECHELE, Maryville, TN (US)

(73) Assignee: ALBEREE PRODUCTS, INC., Halethorpe, MD (US)

(21) Appl. No.: 18/694,737

(22) PCT Filed: Sep. 23, 2022
(86) PCT No.: PCT/US2022/044561

§ 371 Date: Mar. 22, 2024

Related U.S. Application Data
(60) Provisional application No. 63/248,275, filed on Sep. 24, 2021.

(51) Int. Cl. B60S 1/38

(52) U.S. Cl. CPC B60S 1/3881; B60S 1/3889; B60S 2001/3836

(57) ABSTRACT

A wiper blade assembly including a center mounting base having two pockets extending along a length of the center mounting base, a gap between the two pockets, an adapter holder mounted to the center mounting base and including a first recess at a first side of the adapter holder and a second recess at a second side of the adapter holder, and two springs positioned within the two pockets of the center mounting base.

### CROSS-REFERENCE TO RELATED APPLICATIONS

This application claims priority under 35 U.S.C. § 119 (e) to U.S. Provisional Application No. 63/248,275 filed on Sep. 24, 2021.

### TECHNICAL FIELD

The present invention is directed to a wiper blade assembly having a novel center mounting base for attaching springs and spoilers to an adapter holder, and spoilers that have an aerodynamic shape to deflect air flow and improve the performance of the wiper blade assembly.

### BACKGROUND ART

The prior art wiper blade assemblies lack a center mounting base for attaching springs and spoilers that conform to the shape of a corresponding wiping element to improve aerodynamics, as in the present application. For instance, U.S. Pat. No. 6,675,434 describes a wiper blade 10 having a single spring-elastic support element 18, and a wiper strip glued to the spring-elastic support 18, see column 3, lines 52-62 and FIG. 5. U.S. Pat. No. 6,675,434 also discloses an embodiment in which a base body 28 includes hook-like extensions 330 for receiving the wiping element 320, see column 6, lines 20-54 and FIG. 10.

### SUMMARY OF INVENTION

The present invention is directed to an improved center mounting base for retaining wiper blade springs and spoilers and for mounting the springs to an adapter holder. The adapter holder is configured to receive an arm adapter, which is used for attaching the wiper blade assembly to a wiper arm.

The center mounting base includes pockets to receive and secure the springs, tabs to secure the center mounting base to an adapter holder, and at least one alignment hole for ensuring the center mounting base is properly aligned with respect to the adapter holder.

The present invention utilizes a center mounting base that is formed to provide a continuous lower profile that is matched to a lower profile of a first spoiler and a second spoiler. These matching profiles of the center mounting base and the first and second spoilers allows a wiping element to be inserted into a first opening of the first spoiler and to be guided through the center mounting base into a second opening of the second spoiler, or allows the wiping element to be inserted into the second opening of the second spoiler and to be guided through the center mounting base into the first opening of the first spoiler. That is, the wiping element can be guided from either of two opposing ends of center mounting base via the first spoiler or second spoiler.

Two springs may be used in the wiper blade assembly according to an embodiment of the present invention, however, one or more than two springs may be used. The two springs may be retained in the center mounting base by a crimping process. This crimping process ensures the two springs are properly spaced and that the two springs are parallel to one another. The center mounting base may be made of a material suitable for crimping, such as metal or plastic.

A method of assembling the wiper blade assembly according to an embodiment of the present invention includes first sliding two springs into respective pockets of a center mounting base. The two springs may be first slid through a first side of the center mounting base in a first direction or through a second side of the center mounting base in a second direction opposite to the first direction. Both the first direction and the second direction may be along a longitudinal axis of the wiper blade assembly (e.g., a longitudinal direction).

The pockets are formed to substantially conform to the springs, including conforming to an entirety of a bottom surface of each spring and to at least a portion of a top surface of each spring. Further, the pockets are spaced apart by a gap and the gap of the center mounting base is for receiving a wiping element. Each pocket of the center mounting base may include a lip for engaging a side surface of the respective spring to lock the respective spring to the center mounting base.

Next, the center mounting base having the springs mounted thereto may be mounted to an adapter holder by engaging locking tabs of the center mounting base with respective pockets of the adapter holder, such that the center mounting base is fixedly positioned below the adapter holder. The locking tabs of the center mounting base may be provided on a top surface of the center mounting base and the top surface the center mounting base may be moved to engage a lower surface of the adapter holder to force the locking tabs of the center mounting base into the respective pockets of the adapter holder, thereby locking the center mounting base to the adapter holder.

Next, a first spoiler is slid in a first direction onto both springs, such that the springs are positioned within closed pockets of the first spoiler, until the first spoiler is positioned within a first recess of the adapter holder. The first recess of the adapter holder may have a cross-sectional shape that corresponds to an outer cross-sectional shape of the first spoiler. Further, the first direction may be a longitudinal direction.

Next, a second spoiler is slid in a second direction, opposite to the first direction, onto both springs, such that the springs are positioned within closed pockets of the second spoiler, until the second spoiler is positioned within a second recess of the adapter holder. The second recess of the adapter holder has a cross-sectional shape that corresponds to an outer cross-sectional shape of the second spoiler. The first and second spoilers include a channel for receiving a wiping element, which may be designated a first spoiler channel and a second spoiler channel, respectively. Further, the center mounting base is provided with a gap for receiving the wiping element.

Next, a wiping element is slid through one of the first spoiler channel and the second spoiler channel, then through the gap of the center mounting base, then through the other of the first spoiler channel and the second spoiler channel. The wiping element can first be slid into the first spoiler channel in the first direction or into the second spoiler channel in the second direction.

Next, first and second end caps are installed by sliding to engage a pocket of each of the springs and to abut against the first and second spoilers, respectively. Specifically, each of the first and second end caps may be comprised of two pieces that engage one another, including a first element that receives the springs and the wiping element, and a second element that receives the respective one of the first spoiler and the second spoiler. The second element includes two spring securing protrusions (e.g., spring securing cantilevers) engaging two pockets of the first element of the end cap. That is, each spring securing protrusion engages a respective protrusion of the first element. Further, the two spring securing protrusions secure the springs into a fixed position. The first and second elements may be interconnected before the first and second end caps are slid to engage the springs and the respective first and second spoilers. The second element may be positioned above the first element. Alternatively, the first element and the second element may be integrally formed.

Further, the first and second end caps can be installed at any point after the wiping element, the first and second spoilers, and the first and second springs are installed onto the center mounting base, including before or after an adapter holder is installed onto the center mounting base and before or after an arm adapter is mounted to the adapter holder. Alternatively, a single spoiler can be used instead of two separate spoilers.

The first element of each end cap may first be slid into the two springs, and once fully engaged (e.g., the springs extend an entire length of respective spring pockets), the second element of each end cap may then be moved to engage the first element and a respective one of the first and second spoilers by inserting the spring securing protrusions of the second element into the engaging pockets of the first element. As set forth above, the second element of each end cap includes an interior surface having a cross-sectional profile that may be exactly the same, or may be substantially the same as an outer cross-sectional profile of a respective one of the first and second spoilers, so as so engage an outer surface of the respective one of the first and second spoilers. The second element of each end cap may have a force-fit connection with the respective one of the first and second spoilers so as to engage an entirety or less than an entirety of an outer surface of the respective of the first and second spoilers.

That is, each end cap includes two pockets, and each pocket of each end cap engages a notch of each spring for locking the end cap to the spring. Further, each end cap includes a cross-section shape in the longitudinal direction that corresponds to the cross-sectional shape of the respective one of the first and second spoilers. Further, each end cap includes a recess having the cross-section shape in the longitudinal direction that corresponds to the cross-sectional shape of the respective one of the first and second spoilers, and the recess receives the respective one of the first and second spoilers to lock the springs and the respective one of the first and second spoilers in place.

Each of the first and second spoilers may have a continuous profile along its entire length.

Further, each end cap may include two protrusions for engaging notches of the springs. That is, the springs are arranged such that the respective notches face outside of the wiper blade assembly in opposite directions, and the two protrusions of each end cap engage the two notches of the two springs, to lock the end cap to the springs.

After the first and second end caps are installed onto the wiper blade assembly, an arm adapter is installed onto the adapter holder in a manner known in the art.

The wiping element may be comprised of materials known in the art, such as natural and synthetic rubbers, including natural or synthetic polyisoprene, butadiene, ethylene-propylene-diene rubber, neoprene or blends thereof.

Each spoiler includes two closed pockets (e.g., pockets having a closed profile). Each closed pocket of each spoiler may receive a respective spring, including by sliding the respective spoiler with respect to the respective spring, or vice versa.

The springs may have a length extending past the spoilers for attaching an end cap to the springs. The portion of each spring extending past the spoilers may include a notch. Each spring may include two notches formed on opposite sides, each notch being configured to secure an end cap. Adjacent to each notch is a lead-in angle or chamfer to allow the end cap to be more easily inserted into the spring. The notches of the springs are located at a same first side, and the first side may face a direction that is perpendicular to a vertical axis of the wiper blade assembly.

Further scope of applicability of the invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF DRAWINGS

The present invention will become more fully understood from the detailed description given hereinbelow and the accompanying drawings which are given by way of illustration only, and thus are not limitative according to an embodiment of the present invention.

FIG. 1 illustrates a top view of a wiper blade assembly in a fully assembly state according to an embodiment of the present invention.

FIG. 2 illustrates a side view of the wiper blade assembly in its fully assembled state according to an embodiment of the present invention.

FIG. 3 illustrates a side cross-sectional view of the wiper blade assembly in its fully assembled state about A-A of FIG. 1 according to an embodiment of the present invention.

FIG. 4 is a cross-sectional view of the wiper blade assembly about section B-B of FIG. 2.

FIG. 5 is a cross-sectional view of the wiper blade assembly about section C-C of FIG. 2.

FIG. 6 is a cross-sectional view of the wiper blade assembly about section D-D of FIG. 2.

FIG. 7 illustrates a top view of a spring according to an embodiment of the present invention.

FIG. 8 illustrates a side view of the spring according to an embodiment of the present invention.

FIG. 9 is a perspective view of the spring according to an embodiment of the present invention.

FIG. 10 illustrates a top view of a center mounting base according to an embodiment of the present invention.

FIG. 11 illustrates an end view of the center mounting base according to an embodiment of the present invention.

FIG. 12 is a side view of the center mounting base according to an embodiment of the present invention.

FIG. 13 is a perspective view of the center mounting base according to an embodiment of the present invention.

FIG. 14 is a top view of two springs that are aligned for mounting to the center mounting base assembly according to an embodiment of the present invention.

FIG. 15 is a top view of the two springs assembled to the center mounting base according to an embodiment of the present invention.

FIG. 16 is an end view of the two springs assembled/mounted to the center mounting base according to an embodiment of the present invention.

FIG. 17 is a side view of the two springs according to an embodiment of the present invention assembled/mounted to the center mounting base.

FIG. 18 is a perspective view of the two springs according to an embodiment of the present invention.

FIG. 19 is a top view of an adapter holder according to an embodiment of the present invention.

FIG. 20 is an end view of the adapter holder according to an embodiment of the present invention.

FIG. 21 is a side view of the adapter holder according to an embodiment of the present invention.

FIG. 22 is a perspective view of the adapter holder according to an embodiment of the present invention.

FIG. 23 is a top view of a spoiler according to an embodiment of the present invention.

FIG. 24 is an end view of the spoiler according to an embodiment of the present invention.

FIG. 25 is a side view of the spoiler according to an embodiment of the present invention.

FIG. 26 is a perspective view of the spoiler according to an embodiment of the present invention.

FIG. 27 is a top view of the wiper blade assembly of the present invention including the adapter holder, the spoiler, the springs and the center mounting base.

FIG. 28 is an end view of the wiper blade assembly of the present invention.

FIG. 29 is a side view of the wiper blade assembly of the present invention.

FIG. 30 is a bottom view of the wiper blade assembly of the present invention.

FIG. 31 is a top perspective view of the wiper blade assembly of the present invention.

FIG. 32 is a bottom perspective view of the wiper blade assembly of the present invention.

FIG. 33 is a top view of a first element of each end cap according to an embodiment of the present invention.

FIG. 34 is a side view of the first element of the end cap according to an embodiment of the present invention.

FIG. 35 is an end view of the first element of the end cap, showing the two pockets/grooves receiving the two springs and the space between the two longitudinal pockets for receiving a wiping element according to an embodiment of the present invention.

FIG. 36 is a top view of a second element of the end cap according to an embodiment of the present invention.

FIG. 37 is a cross-sectional view of the second element of the end cap about section A-A of FIG. 36 according to an embodiment of the present invention.

FIG. 38 is a side view of the second element of the end cap according to an embodiment of the present invention.

FIG. 39 is an end view of the second element of the end cap according to an embodiment of the present invention.

FIG. 40 is a top view of the wiper blade assembly according to an embodiment of the present invention.

FIG. 41 is a side view of the wiper blade assembly according to an embodiment of the present invention.

FIG. 42 is an end view of the wiper blade assembly of the present invention.

FIG. 43 is a top view of the wiper blade assembly according to an embodiment of the present invention.

FIG. 44 is a side view of the wiper blade assembly according to an embodiment of the present invention.

FIG. 45A is an end view and FIG. 45B is a cross-sectional view about section A-A in

FIG. 44 of the wiper blade assembly according to an embodiment of the present invention.

FIG. 46 is a top view of a wiping element according to an embodiment of the present invention.

FIG. 47 is a side view of the wiping element according to an embodiment of the present invention.

FIG. 48 is an end view of the wiping element according to an embodiment of the present invention.

FIG. 49 is a perspective view of the wiping element according to an embodiment of the present invention.

FIG. 50 is a top view of the wiper blade assembly according to an embodiment of the present invention.

FIG. 51 is a side view of the wiper blade assembly according to an embodiment of the present invention.

FIG. 52 is a perspective view of the wiper blade assembly according to an embodiment of the present invention.

FIG. 53 is a top view of the wiper blade assembly according to an embodiment of the present invention.

FIG. 54 is a side view of the wiper blade assembly according to an embodiment of the present invention.

FIG. 55 is an end view of the wiper blade assembly according to an embodiment of the present invention.

FIG. 56 is a perspective view of the wiper blade assembly according to an embodiment of the present invention.

FIG. 57 is a perspective view of the wiper blade assembly according to an embodiment of the present invention.

FIG. 58 is a side view of a spring according to an embodiment of the present invention.

FIG. 59 is a top view of a spring according to an embodiment of the present invention.

FIG. 60 is a top view of two springs installed onto the center mounting base according to an embodiment of the present invention.

FIG. 61 is a side view of the springs installed onto the center mounting base according to an embodiment of the present invention.

FIG. 62 is a cross-sectional view of the springs installed onto the center mounting base according to an embodiment of the present invention about section A-A of FIG. 61.

FIG. 63 is a cross-sectional view of the springs installed onto the center mounting base according to an embodiment of the present invention about section B-B of FIG. 60.

FIG. 64 is a cross-sectional view of the springs installed onto the center mounting base according to an embodiment of the present invention about section C-C of FIG. 60.

FIG. 65 is a side view of the end cap according to an embodiment of the present invention.

FIG. 66 is a bottom view of the end cap according to an embodiment of the present invention.

FIG. 67 is an end view of the end cap according to an embodiment of the present invention.

FIG. 68 is bottom perspective view of the end cap according to an embodiment of the present invention.

FIG. 69 is a top perspective view of the end cap according to an embodiment of the present invention.

### DESCRIPTION OF EMBODIMENTS

The present invention will now be described with reference to the accompanying drawings, wherein the same reference numerals have been used to identify the same or similar elements throughout the several views. The term “may” used throughout the specification is interchangeable with “can” and is used to provide alternatives to the design of the wiper blade assembly.

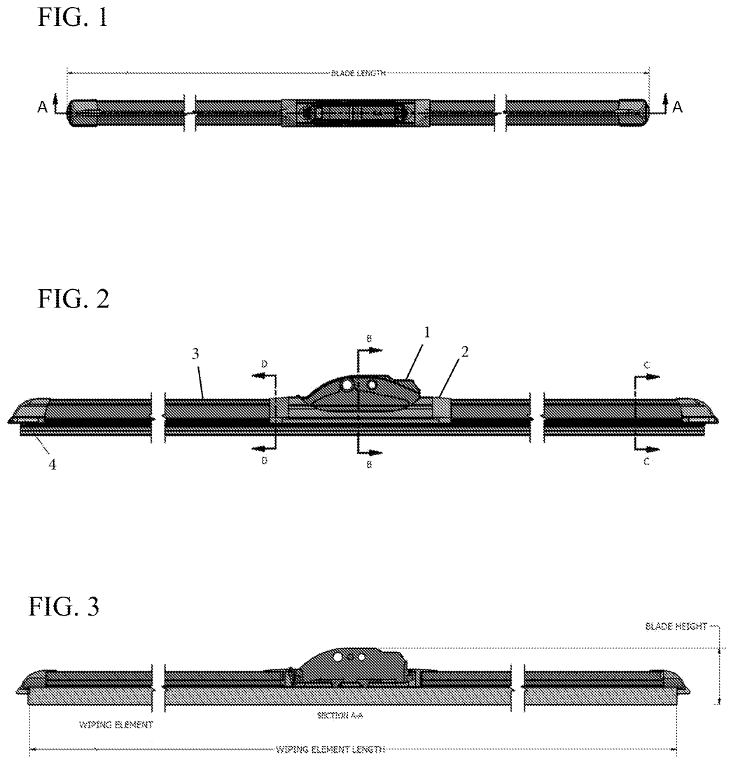

As shown in FIGS. 1-69, a wiper blade assembly according to an embodiment of the present invention includes an arm adapter 1 (e.g., wiper arm adapter), an adapter holder 2, spoilers 3, end caps 4, a center mounting base 5, springs 6 and a wiping element 7. Wiping element 7 can also be referred to as a “squeegee” or in any known manner, and can be comprised of rubber, synthetic rubber, other synthetic elastomeric materials, such as silicone, plastic, thermoplastic and the like. The arm adapter 1 and the adapter holder 2 may be universally designed, so they can be attached to any known wiper arm. Further, there may be a single arm adapter 1, a single adapter holder 2, two spoilers 3, two end caps 4, a single center mounting base 5, two springs 6 and a single wiping element 7. However, one spring 6 or more than two springs 6 may be used, and two or more wiping elements 7 may be used.

FIG. 1 illustrates a top view of the wiper blade assembly in a fully assembly state, with end caps 4 installed at either end (e.g., both longitudinal ends) of the wiper blade assembly according to an embodiment of the present invention. FIG. 2 illustrates a side view of the wiper blade assembly in its fully assembled state according to an embodiment of the present invention, including the end caps 4, including the two springs 6, the wiping element 7, the first and second spoilers, the first element 4.1 of each end cap 4 and the second element 4.2 of each end cap 4, the spoilers 3, the center mounting base 5, the adapter holder 2 (e.g., universal adapter holder), and the arm adapter 1. In the figures, first element 4.1 is referred to as #4.1 end cap, and likewise, second element 4.2 is referred to as #4.2 end cap. FIG. 3 illustrates a side cross-sectional view of the wiper blade assembly in its fully assembled state about A-A of FIG. 1 according to an embodiment of the present invention. FIGS. 1-3 illustrate the same wiper blade assembly, with differing views to aid in the understanding of the invention. The term “squeegee” is interchangeable with “wiper,” and the “squeegee length” in FIG. 3 refers to the length of the wiper.

Each component of the wiper blade assembly according to all of the embodiments of the present invention can be made of any known type of material, such as plastic, thermoplastic, rubber, synthetic rubber, metal, and the like.

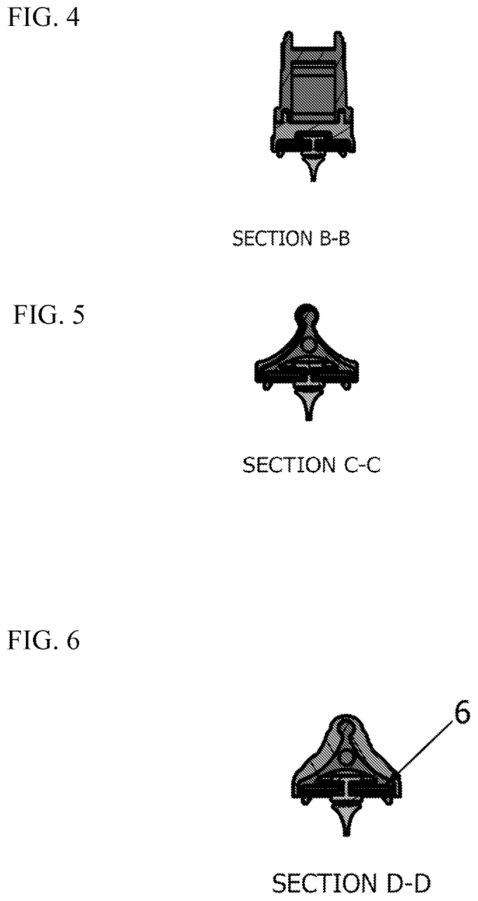

FIGS. 4-6 illustrate cross-sectional views of the wiper blade assembly about section B-B, section C-C and section D-D of FIG. 2, respectively, according to an embodiment of the present invention. That is, FIG. 4 is a cross-sectional view of the wiper blade assembly about section B-B of FIG. 2, FIG. 5 is a cross-sectional view of the wiper blade assembly about section C-C of FIG. 2, and FIG. 6 is a cross-sectional view of the wiper blade assembly about section D-D of FIG. 2.

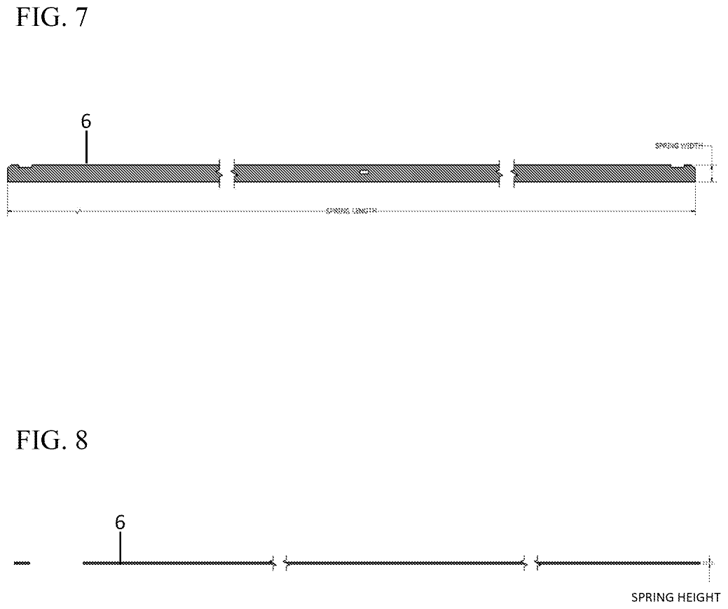

FIG. 7 illustrates a top view of a spring 6 according to an embodiment of the present invention, including a notch at first and second ends of the spring 6 to fix a respective end cap 4 thereto and a chamfered portion adjacent to each notch to allow for each end cap 4 to be more easily installed onto the springs 6. Two springs 6 are used in each wiper blade assembly, and the two springs 6 are arranged such that the notches face opposing directions.

The notches of a first spring face a third direction that is perpendicular to the longitudinal direction, and the notches of the second spring face a fourth direction that is opposite to the third direction. More specifically, the first spring includes a first notch and a second notch, the first notch of the first spring engages a first protrusion of the first end cap, and the second notch of the first spring engages a first protrusion of the second end cap. Similarly, the second spring includes a first notch and a second notch, the first notch of the second spring engages a second protrusion of the first end cap, and the second notch of the second spring engages a second protrusion of the second end cap.

FIG. 8 illustrates a side view of a single spring 6 to provide a perspective of a spring height relative to the spring length according to an embodiment of the present invention.

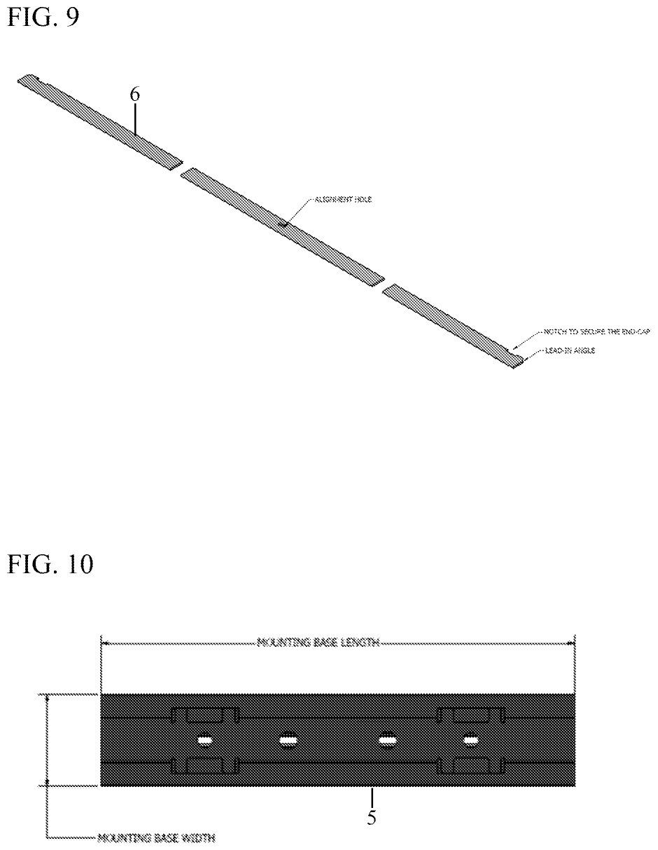

FIG. 9 is a perspective view of a spring 6 showing a first notch at a first end and a second notch at a second end, each of the first notch and the second notch facing a same direction (e.g., third direction) according to an embodiment of the present invention. Further, each spring 6 is provided with an alignment hole and a “lead-in angle” or chamfer for leading in or permitting easy (e.g., easier) insertion of an end cap 4.

FIG. 10 illustrates a top view of the center mounting base 5 according to an embodiment of the present invention, including protrusions formed on a top surface of the center mounting base 5 for engaging respective pockets of the adapter holder 2.

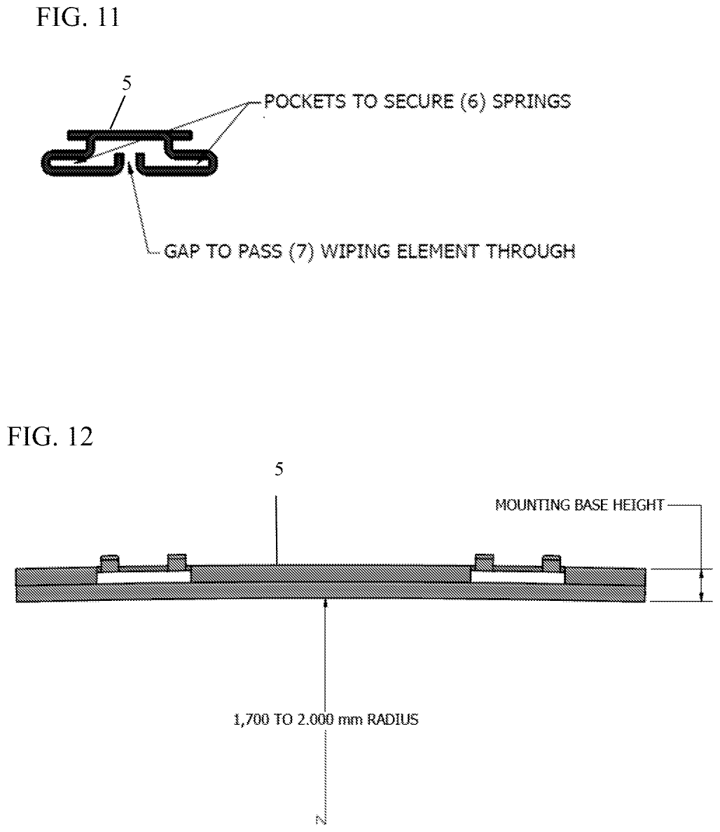

FIG. 11 illustrates an end view of the center mounting base 5 according to an embodiment of the present invention, which shows two open pockets for receiving two springs 6 and a gap between the two pockets for receiving a wiping element 7 therethrough. The wiping element 7 engages the center mounting base 5 and is locked in place by having a shape that fits within the gap.

FIG. 12 is a side view of the center mounting base 5, showing the height of the center mounting base 5 relative to the length of the center mounting base 5 according to an embodiment of the present invention. Further, FIG. 12 illustrates a concave shape of the center mounting base 5 along its longitudinal axis, in which a lower portion (e.g., lower surface) of the center mounting base 5 that retains the wiping element 7 has a curvature that simulates (e.g., substantially matches) the curvature of a windshield. As illustrated in FIG. 12, the bottom surface of the center mounting base 5 optimally has a radius of curvature between 1,700 and 2,000 mm in order to improve contact with the windshield. After assembly, the lower portion of the center mounting base 5 matches a lower portion of the spoiler 3, providing a matching transition between the spoiler 3 and the center mounting base 5. This concave shape of the center mounting base 5 is an essential component to the wiper blade assembly of the present invention.

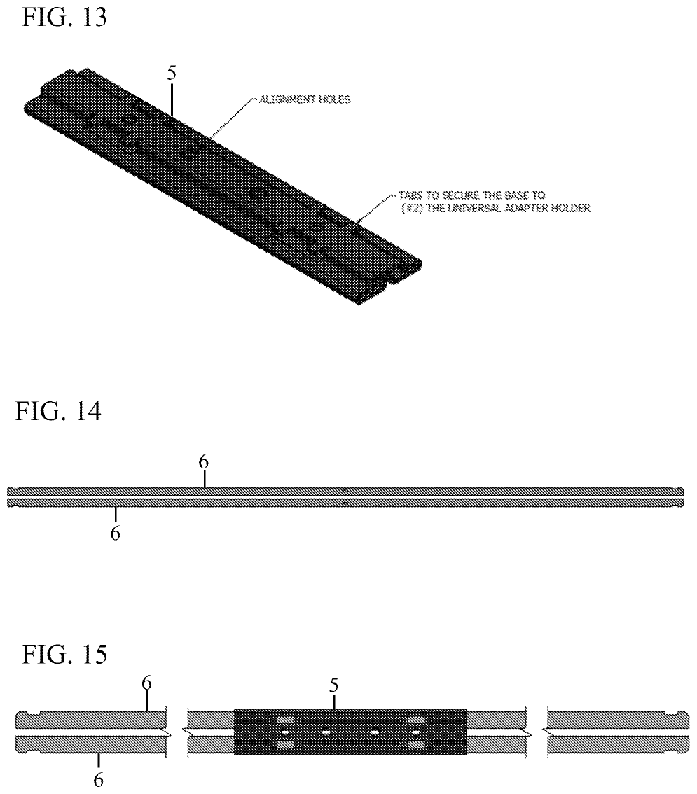

FIG. 13 is a perspective view of the center mounting base 5 including the tabs (e.g., locking tabs) to secure the center mounting base 5 to the adapter holder 2, and alignment holes according to an embodiment of the present invention. The alignment holes of the center mounting base 5 align with corresponding alignment holes of the adapter holder 2.

FIG. 14 is a top view of two springs 6 that are aligned for mounting to the center mounting base 5 and each of the two springs 6 have notches facing opposing directions for attachment to the end caps 4 according to an embodiment of the present invention.

FIG. 15 is a top view of the two springs 6 assembled to the center mounting base 5 according to an embodiment of the present invention.

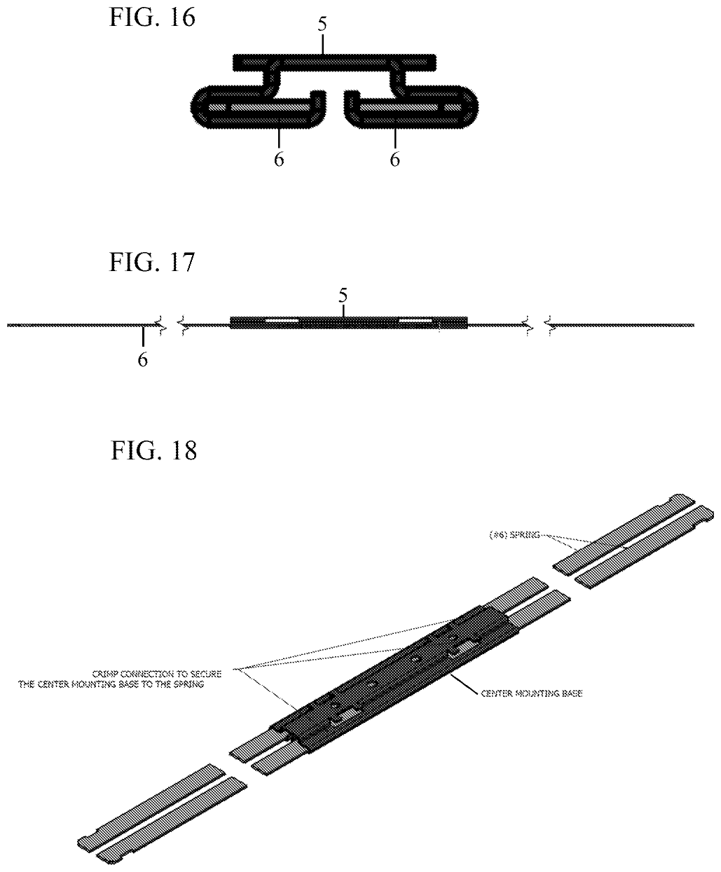

FIG. 16 is an end view of the two springs 6 assembled/mounted to the center mounting base 5 according to an embodiment of the present invention. As shown in FIG. 16, the springs 6 are housed/assembled into corresponding grooves of the center mounting base. FIG. 17 is a side view of the two springs 6 according to an embodiment of the present invention assembled/mounted to the center mounting base 5. FIG. 18 is a perspective view of the two springs 6 according to an embodiment of the present invention assembled/mounted to the center mounting base 5. The center mounting base 5 is crimped to the two springs 6 to lock the center mounting base 5 to the two springs 6. Specifically, the center mounting base 5 is crimped along the sides, as shown in FIG. 18, and may be comprised of an elastic material, such as a metal including steel, aluminum, or the like to allow for the crimping operation. A longitudinal center portion of the center mounting base 5 can be raised in relation to longitudinal sides of the center mounting base 5, with the longitudinal sides housing the springs 6, as shown in FIG. 18.

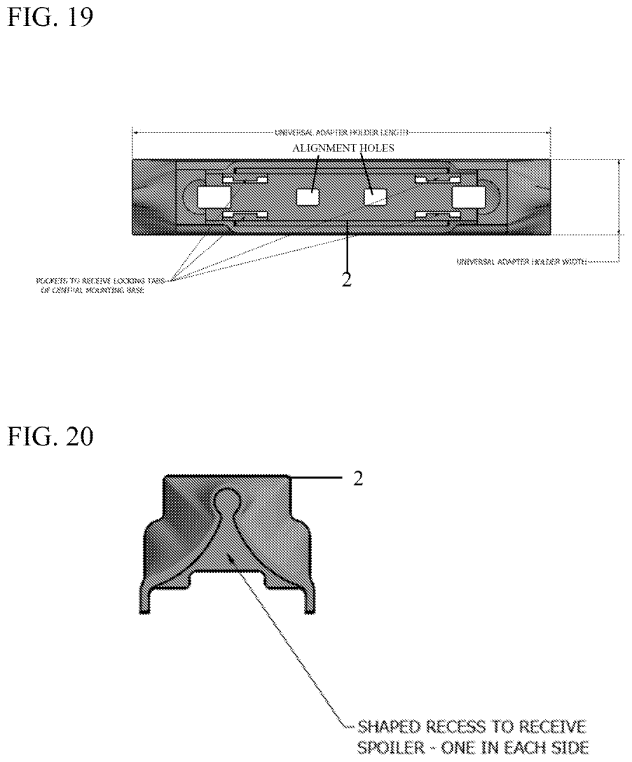

FIG. 19 is a top view of the adapter holder 2 according to an embodiment of the present invention illustrating the length of the adapter holder 2 relative to the width of the adapter holder 2, and pockets for receiving locking tabs of the center mounting base 5. The adapter 2 includes alignment holes that permit easy alignment of the universal arm adapter.

FIG. 20 is an end view of the adapter holder 2 according to an embodiment of the present invention illustrating a recess shaped to receive a respective spoiler 3. The recess of the adapter holder 2 faces outside of the adapter holder 2, and the adapter holder 2 includes two recesses, a first recess at a first side and a second recess at a second side. The first recess receives and engages a first spoiler 3, and the second recess receives and engages a second spoiler 3. Each of the first spoiler 3 and the second spoiler 3 have a shape corresponding to (e.g., having the same shape as or having a similar shape to) the first recess and the second recess of the adapter holder 2. That is, the adapter holder 2 is shaped to lock/fix the first and second spoilers in place, including having a rounded top portion, which restricts (or completely eliminates) downward movement (perpendicular to the longitudinal direction of the adapter holder 2) to aid in locking the first and second spoilers 3 in place.

Each of the first and second recesses of the adapter holder 2 can be comprised of an elastic (e.g., flexible) material in order to aid installation of the first and second spoilers 3. Elastic materials can include rubber, synthetic rubber, nitrile rubber, silicone rubber, urethane rubbers, polyether rubbers, chloroprene rubber, Ethylene Vinyl Acetate (EVA) rubber, etc. Alternatively, each of the first and second recesses of the adapter holder 2 can be comprised of any known type of plastic, thermoplastic or metal.

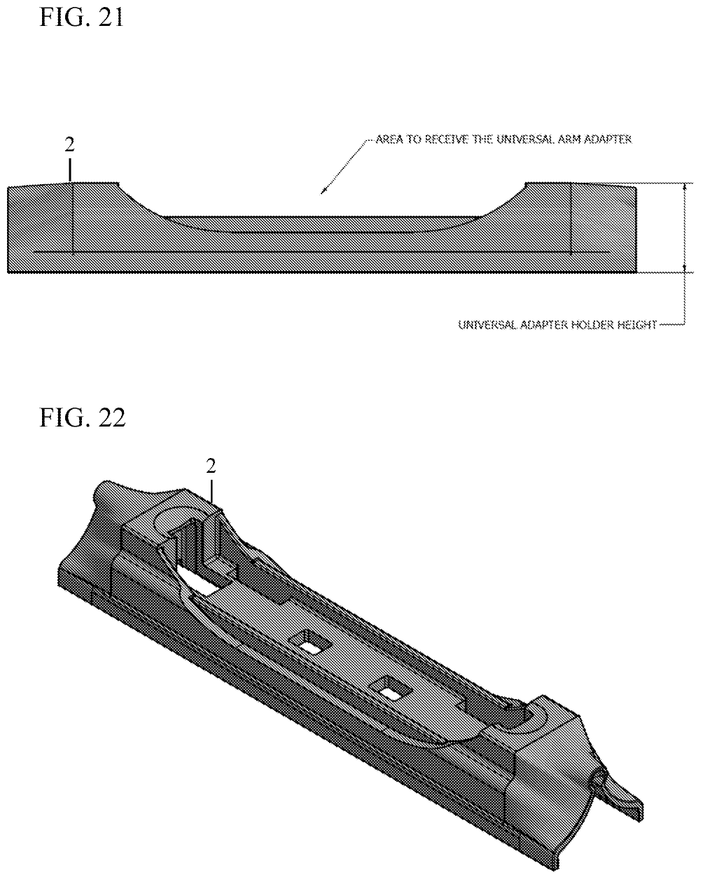

FIG. 21 is a side view of the adapter holder 2 according to an embodiment of the present invention illustrating a top surface having an area (e.g., groove) for receiving an arm adapter 1, and illustrating the height of the adapter holder 2 relative to the length of the adapter holder 2.

FIG. 22 is a perspective view of the adapter holder 2 according to an embodiment of the present invention. The adapter holder 2 is shown with pockets to receive locking tabs of the center mounting base 5. The adapter holder 2 is constructed to receive and attach, via clips and or any manner known in the art, to a universal arm adapter.

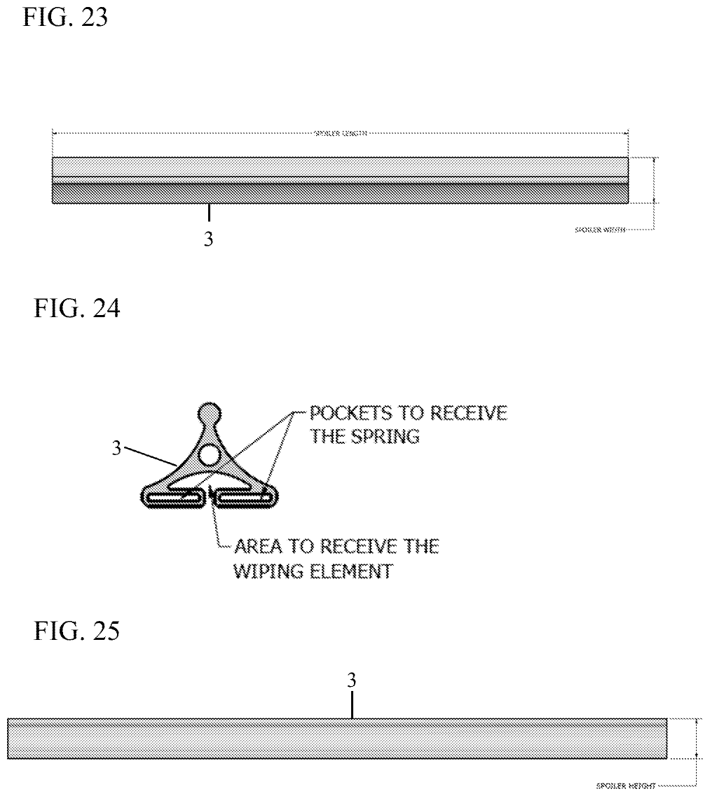

FIG. 23 is a top view of the spoiler 3 according to an embodiment of the present invention, illustrating the spoiler length relative to the spoiler width.

FIG. 24 is an end view of the spoiler 3 according to an embodiment of the present invention illustrating two pockets for receiving the two springs 6 and an area between the two pockets for receiving a wiping element 7. The two pockets of the spoiler 3 have a closed cross-section. Each spoiler 3 is provided with a circular hole extending along an entire length to improve flexibility of the spoiler 3 and to improve contact of the wiper blade assembly to a windshield, thus improving performance of the wiper blade assembly.

FIG. 25 is a side view of the spoiler 3 according to an embodiment of the present invention, illustrating the spoiler length relative to the spoiler height.

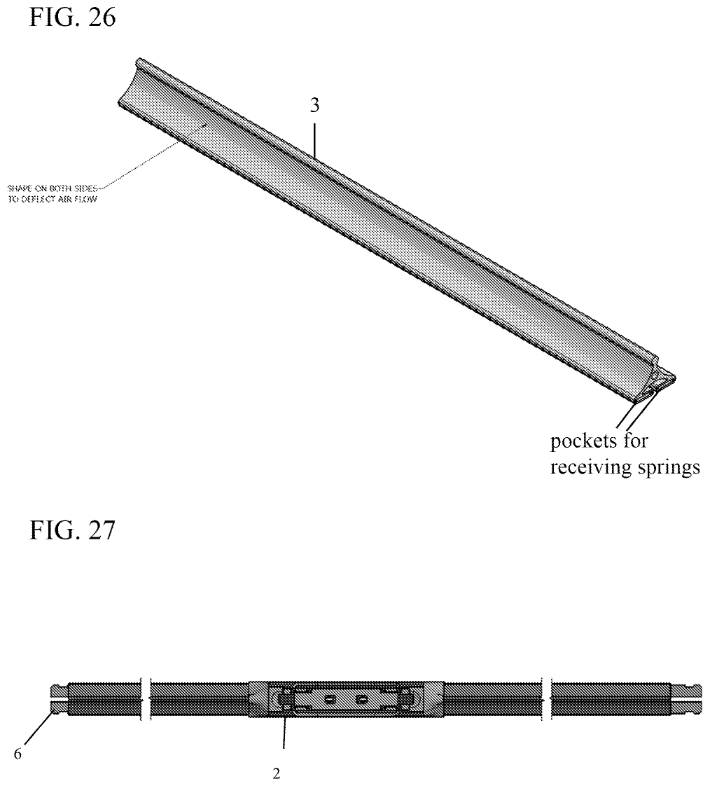

FIG. 26 is a perspective view of the spoiler 3 according to an embodiment of the present invention. The spoilers 3 have a curved shape on both sides that deflects air flow to improve aerodynamics by having a continuous profile. Additionally, each of the spoilers 3 are provided with pockets for receiving the two springs 6. Each of the pockets can have a closed cross-section to completely encompass (e.g., completely surround) a respective one of the two springs 6.

FIG. 27 is a top view of the wiper blade assembly according to an embodiment of the present invention including the adapter holder 2, the spoiler 3, the springs 6 and the center mounting base 5, but without end caps 4 being shown.

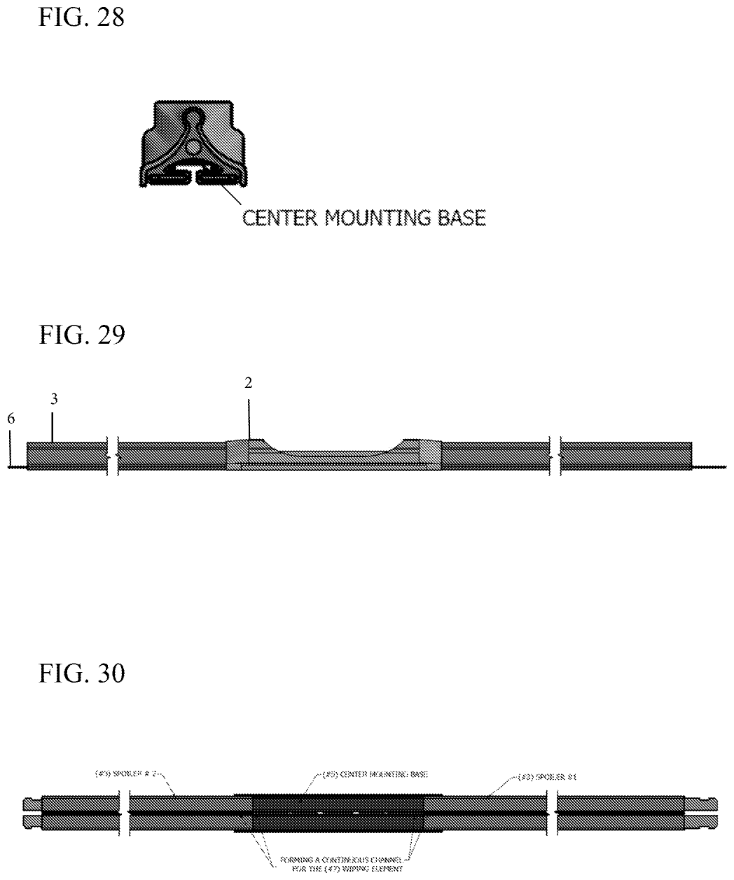

FIG. 28 is an end view of the wiper blade assembly according to an embodiment of the present invention including the adapter holder 2, the spoiler 3, the springs 6 and the center mounting base 5.

FIG. 29 is a side view of the wiper blade assembly according to an embodiment of the present invention including the adapter holder 2, the spoiler 3, the springs 6 and the center mounting base 5.

FIG. 30 is a bottom view of the wiper blade assembly according to an embodiment of the present invention including the adapter holder 2, the spoiler 3, the springs 6 and the center mounting base 5. A continuous channel is formed through each spoiler 3 (e.g., through a bottom surface of each spoiler 3) and the center mounting base 5 for receiving a wiping element 7.

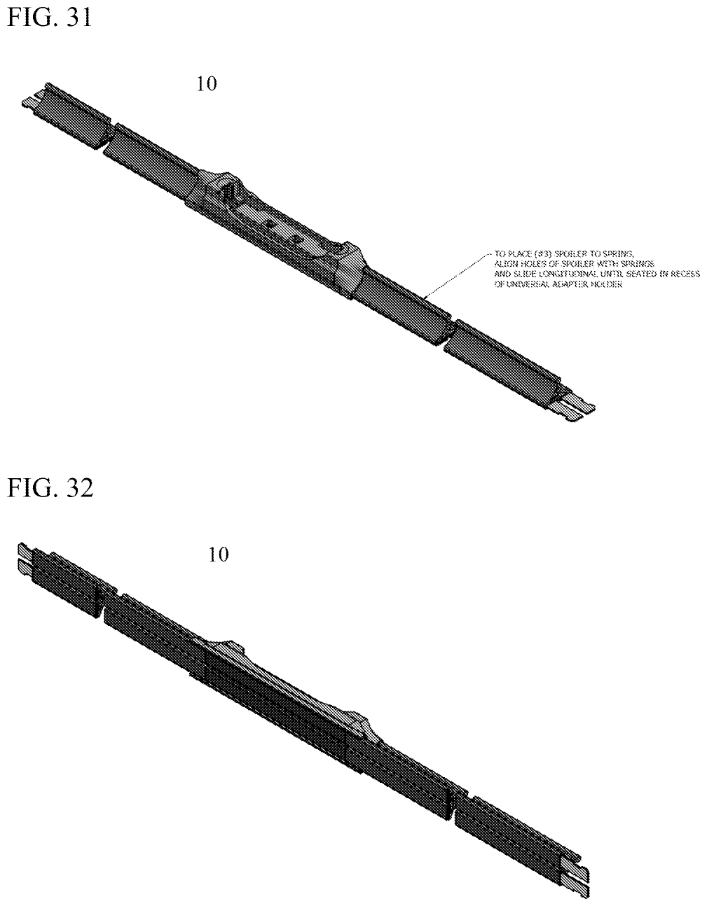

FIG. 31 is a top perspective view of the wiper blade assembly according to an embodiment of the present invention including the adapter holder 2, the spoiler 3, the springs 6 and the center mounting base 5.

FIG. 32 is a bottom perspective view of the wiper blade assembly according to an embodiment of the present invention including the adapter holder 2, the spoiler 3, the springs 6 and the center mounting base 5.

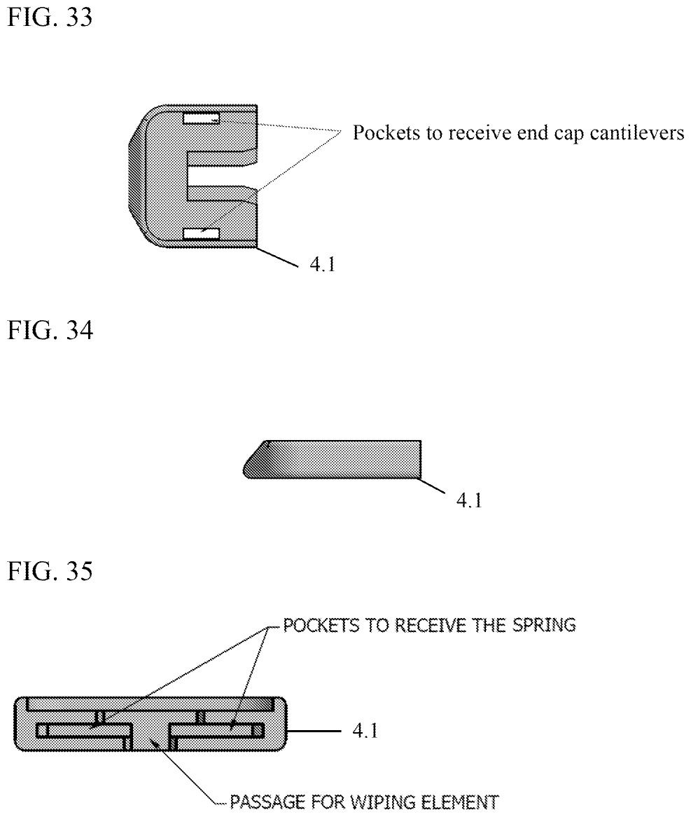

FIG. 33 is a top view of the first element 4.1 of each end cap 4 (e.g., two end caps 4 are used for the wiper blade assembly) according to an embodiment of the present invention. The first element 4.1 includes two vertical pockets (e.g., vertically extending pockets) extending through a height of the first element 4.1 to receive two longitudinal protrusions/cantilevers of the second element 4.2, and two pockets/grooves extending through the length of the first element 4.1 to receive the two springs 6.

FIG. 34 is a side view of the first element 4.1 of the end cap 4 according to an embodiment of the present invention. FIG. 35 is an end view of the first element 4.1 of the end cap 4, showing the two pockets/grooves receiving the two springs 6 and the space between the two longitudinal pockets for receiving the wiping element 7 according to an embodiment of the present invention.

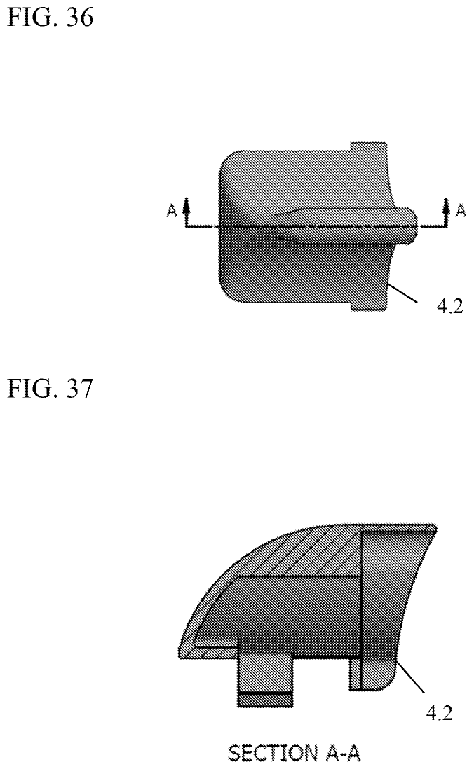

FIG. 36 is a top view of the second element 4.2 of the end cap 4 according to an embodiment of the present invention. The second element 4.2 of the end cap 4 includes a curved top surface to match with a shape of the spoiler 3 and to provide enhanced aerodynamics. That is, the interior surface of the second element 4.2 of the end cap 4 has a shape corresponding to a shape of a top surface of the spoiler 3, such that the spoiler 3 fits within the second element 4.2.

FIG. 37 is a cross-sectional view of the second element 4.2 of the end cap 4 about section A-A of FIG. 36 according to an embodiment of the present invention.

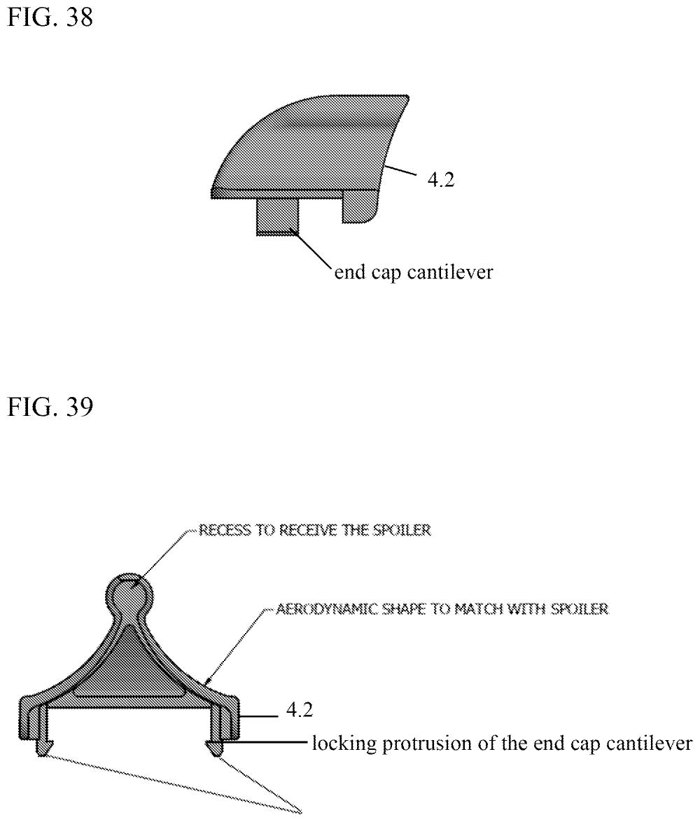

FIG. 38 is a side view of the second element 4.2 of the end cap 4 according to an embodiment of the present invention. FIG. 38 illustrates the end cap protrusion that will engage a corresponding notch of a spring 6. That is, each second element 4.2 will include two end cap cantilevers protrusions, which engage the pockets of the first element 4.1 (the pockets are shown and labeled in FIG. 33).

FIG. 39 is an end view of the second element 4.2 of the end cap 4 according to an embodiment of the present invention, including a recess for receiving the spoiler 3, an outer aerodynamic shape to match the shape of the spoiler 3, and spring securing cantilevers for engaging the vertical pockets of the first element 4.1 of the end caps 4. Each of the spring securing cantilevers can be comprised of a flexible (e.g., elastic) material. Further, each of the spring securing cantilevers have a locking protrusion, which is labeled in FIG. 39, to engage a lower surface of the first element 4.1 to lock (e.g., fix) the first element 4.1 in place.

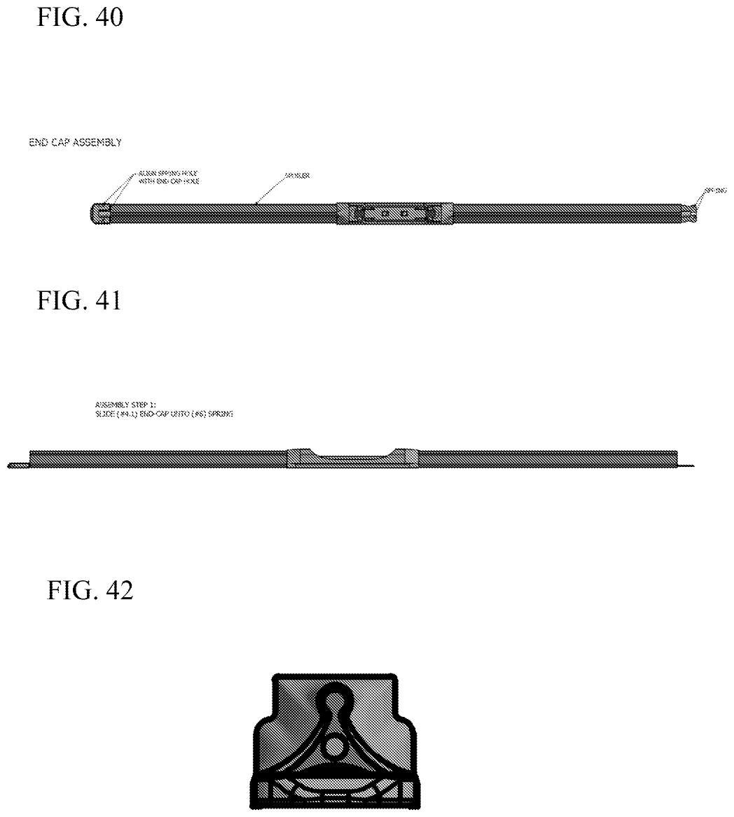

FIG. 40 is a top view of the wiper blade assembly according to an embodiment of the present invention including the adapter holder 2, the spoiler 3, the springs 6, the center mounting base 5 and the first elements 4.1 of the end caps 4. The spring holes are to be aligned with the end cap holes.

FIG. 41 is a side view of the wiper blade assembly according to an embodiment of the present invention, including the adapter holder 2, the spoilers 3, the springs 6, the center mounting base 5 and the first elements 4.1 of the end caps 4. The first element 4.1 of each end cap 4 is first slid onto the springs 6. First, the spoilers 3 are assembled to the center mounting base 5 by sliding the spoilers 3 into a corresponding groove (e.g., aperture, hole, etc.). Next, two springs 6 are assembled to the spoiler(s) 3 by sliding into corresponding groves of the spoiler(s), which are shown in FIG. 26. Notches of the springs 6 face away from each other, to allow for mounting of the end caps 4 to the springs 6. Then, the first element 4.1 of each end cap 4 is slid onto the springs 6. FIG. 35 illustrates the pockets of each first element 4.1 to receive the springs 6.

FIG. 42 is an end view of the wiper blade assembly according to an embodiment of the present invention including the adapter holder 2, the spoiler 3, the springs 6, the center mounting base 5 and the first element 4.1 of the end caps 4.

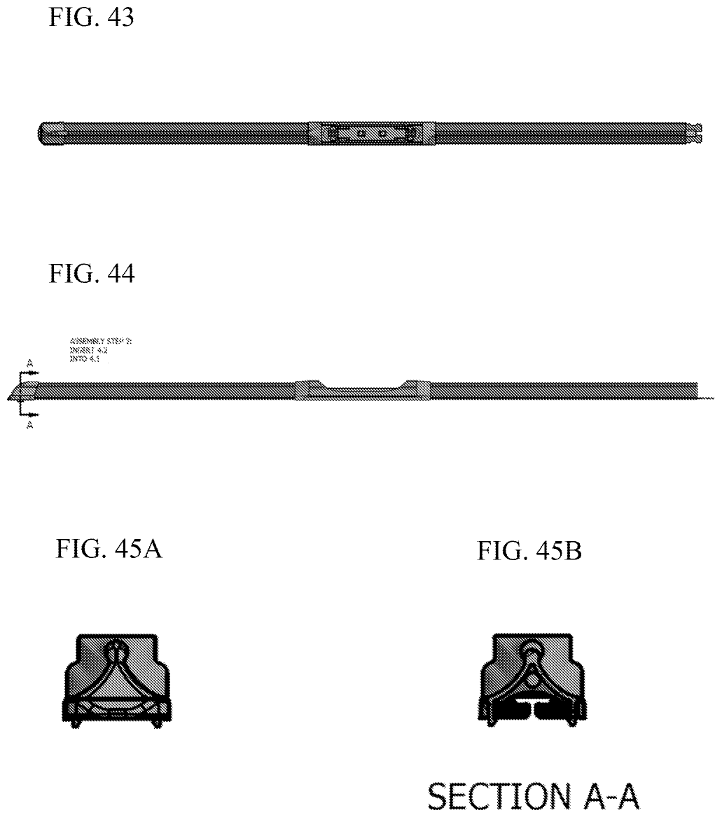

FIG. 43 is a top view of the wiper blade assembly according to an embodiment of the present invention including the adapter holder 2, the spoiler 3, the springs 6, the center mounting base 5, and a first end cap 4 having the second element 4.2.

FIG. 44 is a side view of the wiper blade assembly according to an embodiment of the present invention including the adapter holder 2, the spoiler 3, the springs 6, the center mounting base 5, and a first end cap 4 having the second element 4.2.

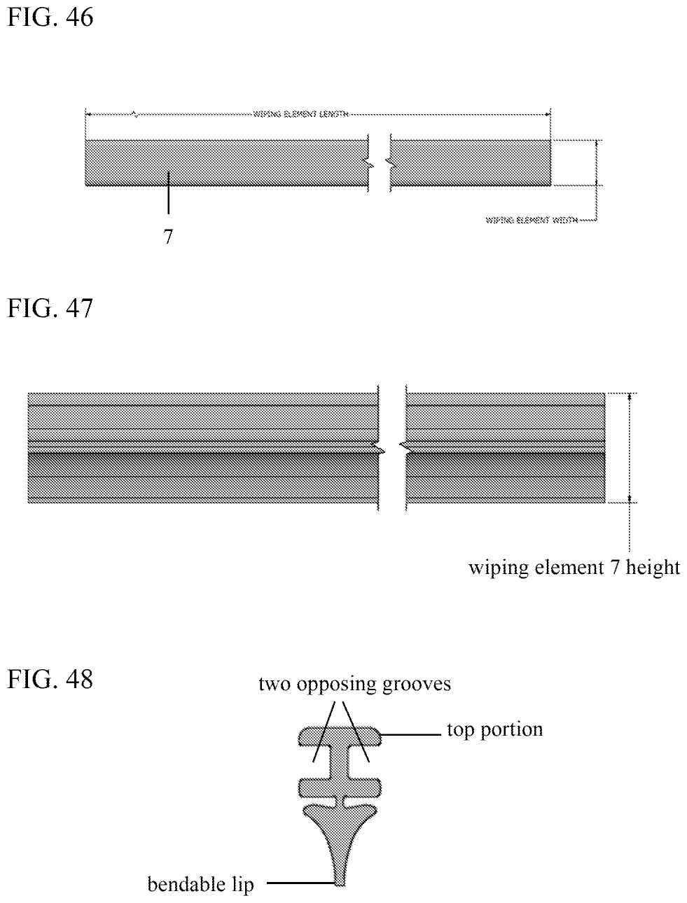

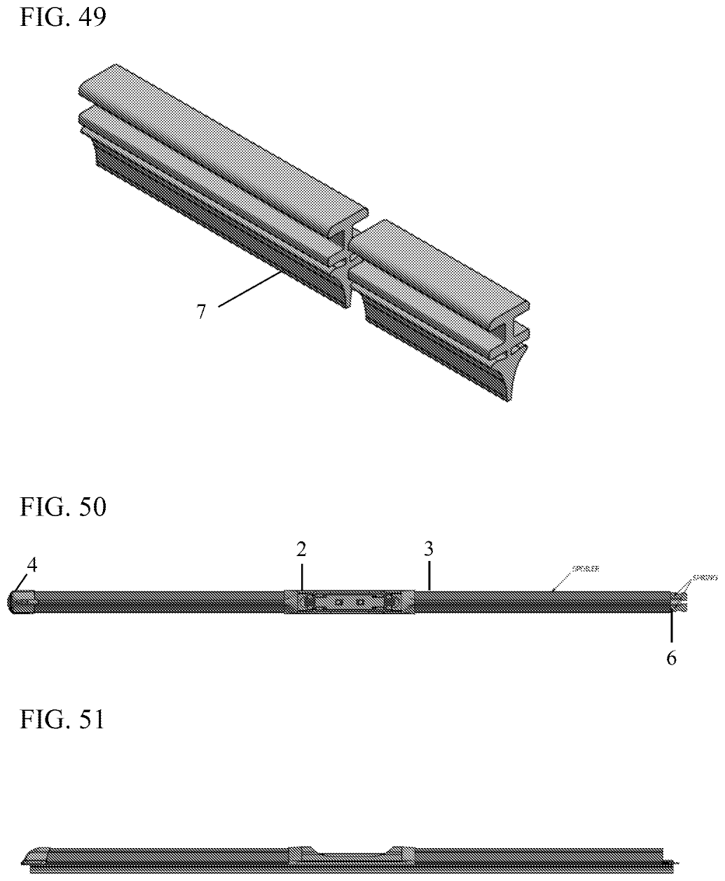

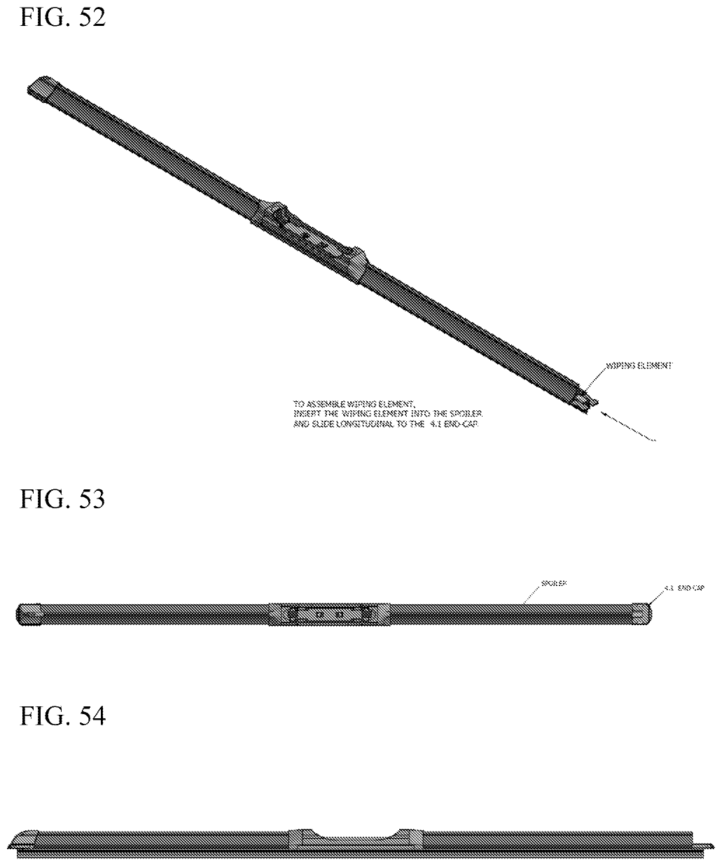

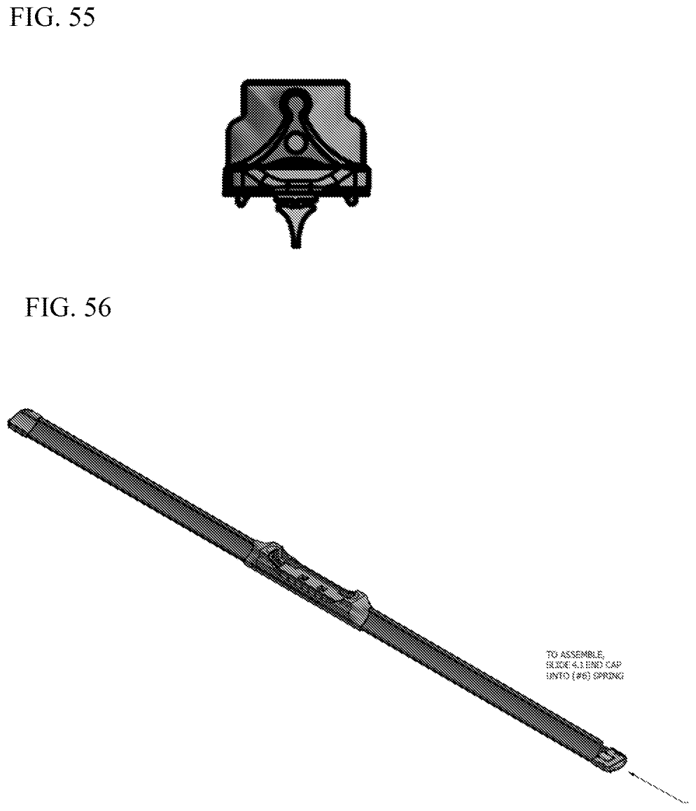

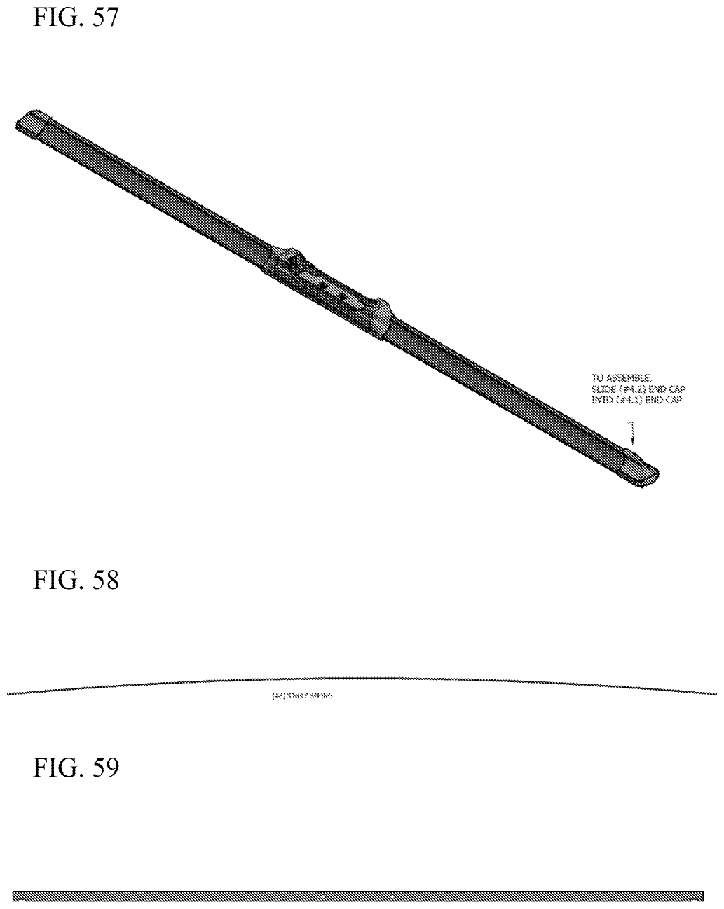

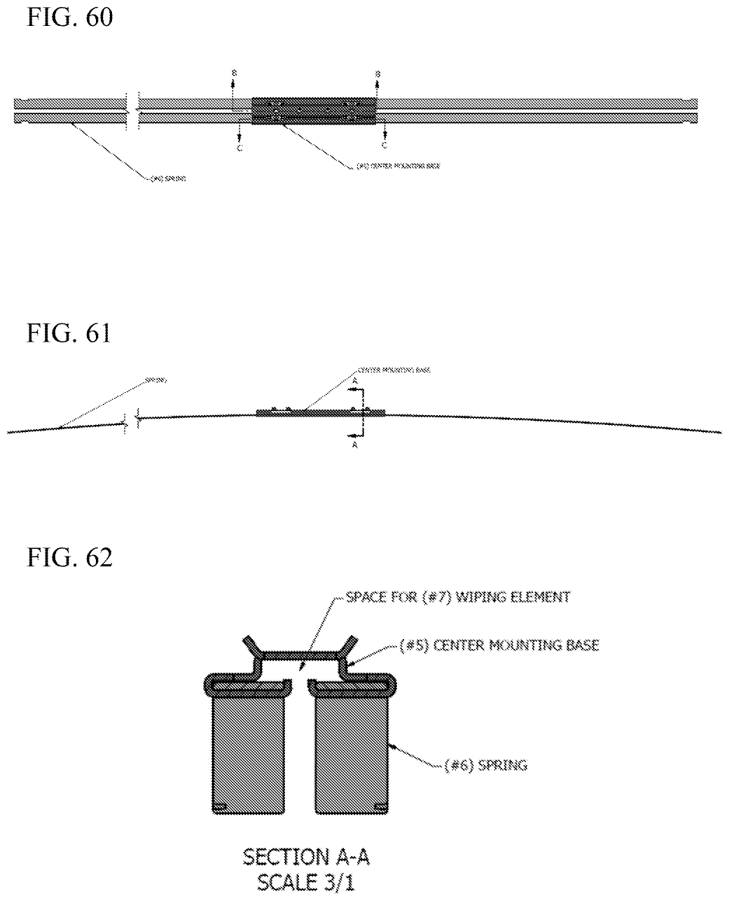

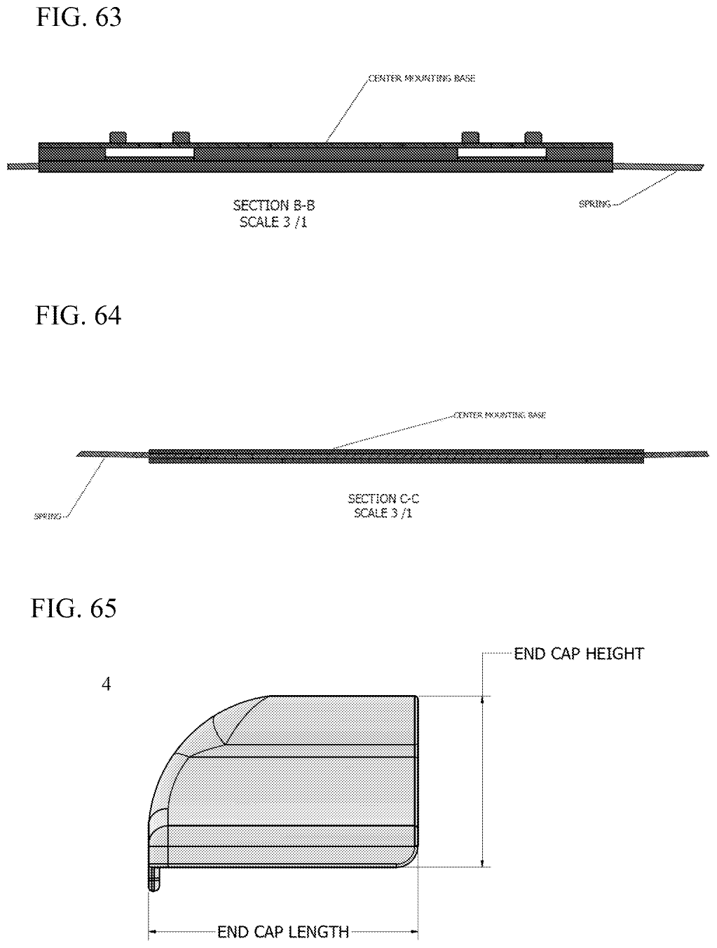

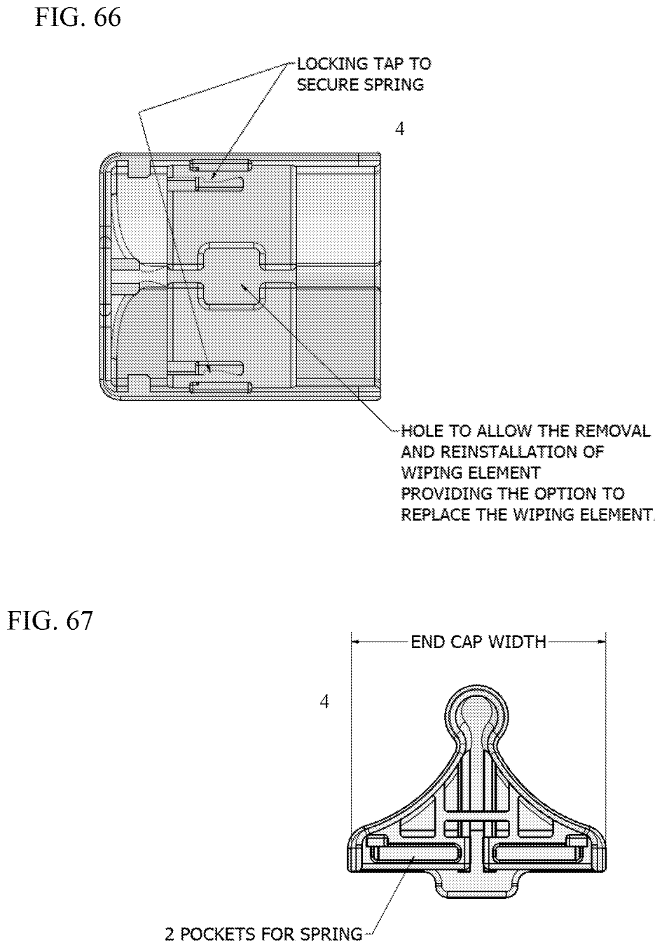

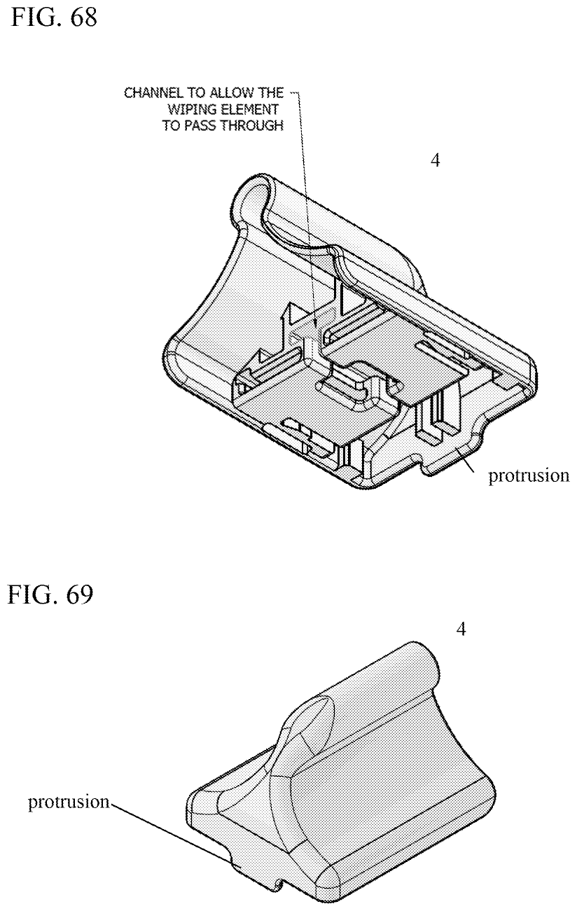

FIG. 45A is an end view and FIG. 45B is a cross-sectional view about section A-A in FIG. 44 of the wiper blade assembly according to an embodiment of the present invention including the adapter holder 2, the spoiler 3, the springs 6, the center mounting base 5, and the first end cap 4 having both the first element 4.1 and the second element 4.2 at a first side and a second side provided without an end cap 4.

FIG. 46 is a top view of the wiping element 7 according to an embodiment of the present invention, illustrating the length of the wiping element 7 with respect to the width of the wiping element 7.

FIG. 47 is a side view of the wiping element 7 according to an embodiment of the present invention, illustrating the height of the wiping element 7 with respect to the length of the wiping element 7.

FIG. 48 is an end view of the wiping element 7 according to an embodiment of the present invention. The wiping element 7 is assembled to the spoiler 3 by sliding the wiping element 7 through the spoilers 3 and through the universal adapter holder 2. As illustrated in FIG. 24, each spoiler 3 includes an area to receive the wiping element 7, and the wiping element 7, as shown in FIG. 48, includes two opposing grooves that engage this area of the spoiler 3. A top portion of the wiping element 7 can engage a surface (e.g., interior surface) of each of the spoilers 3 to fix the wiping element 7 in place.

FIG. 49 is a perspective view of the wiping element 7 according to an embodiment of the present invention.

FIG. 50 is a top view of the wiper blade assembly according to an embodiment of the present invention including the adapter holder 2, the spoiler 3, the springs 6, the center mounting base 5, and a first end cap 4 installed on a first end of the wiper blade assembly and a second end of the wiper blade assembly to receive a second end cap 4.

FIG. 51 is a side view of the wiper blade assembly according to an embodiment of the present invention including the adapter holder 2, the spoiler 3, the springs 6, the center mounting base 5, a first end cap 4 installed on a first end of the wiper blade assembly and a second end of the wiper blade assembly to receive a second end cap 4, and a wiping element 7.

FIG. 52 is a perspective view of the wiper blade assembly according to an embodiment of the present invention including the adapter holder 2, the spoiler 3, the springs 6, the center mounting base 5, the wiping element 7, and a first end cap 4 installed on a first end of the wiper blade assembly and a second end of the wiper blade assembly to receive a second end cap 4.

FIG. 53 is a top view of the wiper blade assembly according to an embodiment of the present invention including the adapter holder 2, the spoiler 3, the springs 6, the center mounting base 5, the wiping element 7, and a first end cap 4 installed on a first end of the wiper blade assembly and a second end of the wiper blade assembly having the first element 4.1 of the second end cap 4.

FIG. 54 is a side view of the wiper blade assembly according to an embodiment of the present invention including the adapter holder 2, the spoiler 3, the springs 6, the center mounting base 5, the wiping element 7, and a first end cap 4 installed on a first end of the wiper blade assembly and a second end of the wiper blade assembly having the first element 4.1 of the second end cap 4.

FIG. 55 is an end view of the wiper blade assembly according to an embodiment of the present invention including the adapter holder 2, the spoiler 3, the springs 6, the center mounting base 5, the wiping element 7, and a first end cap 4 installed on a first end of the wiper blade assembly and a second end of the wiper blade assembly having the first element 4.1 of the second end cap 4.

FIG. 56 is a perspective view of the wiper blade assembly according to an embodiment of the present invention including the adapter holder 2, the spoiler 3, the springs 6, the center mounting base 5, the wiping element 7, and a first end cap 4 installed on a first end of the wiper blade assembly and a second end of the wiper blade assembly having the first element 4.1 of the second end cap 4. An arrow is shown to indicate the insertion direction of the first element 4.1 onto the springs 6.

FIG. 57 is a perspective view of the wiper blade assembly according to an embodiment of the present invention including the adapter holder 2, the spoiler 3, the springs 6, the center mounting base 5, the wiping element 7, a first end cap 4 installed on a first end of the wiper blade assembly and a second end cap 4 installed on a second end of the wiper blade assembly. FIG. 57 shows the second element 4.2 installed onto the first element 4.1.

FIGS. 50-57 illustrate a final assembly of the wiper blade assembly. As shown in FIGS. 50-52, the first end cap 4 is mounted and installed onto the first end of the wiper blade assembly, and the wiping element 7 is to be inserted into the spoiler 3 and slid until it engages the first end cap 4. Thereafter, the second end cap 4 is installed, starting with the first element 4.1 of the second end cap 4, as shown in FIGS. 54 and 56. That is, the first element 4.1 of the second end cap 4 is inserted into the two springs 6. Then, as shown in FIG. 57, the second element 4.2 of the second end cap 4 is inserted into the first element 4.1 of the second end cap 4 to complete the assembly.

FIG. 58 is a side view of a spring 6 according to an embodiment of the present invention. FIG. 58 illustrates the curvature of a single spring 6, which is curved to match or at least partially match the curvature of a windshield to which the assembled windshield blade assembly is to rest on once assembled to a vehicle.

FIG. 59 is a top view of a spring 6 according to an embodiment of the present invention, illustrating the two notches and two spaced apart holes symmetrically located about a center of the spring 6. However, the holes may be omitted from the springs 6.

FIG. 60 is a top view of two springs 6 installed onto the center mounting base 5 according to an embodiment of the present invention.

FIG. 61 is a side view of the springs 6 installed onto the center mounting base 5 according to an embodiment of the present invention.

FIG. 62 is a cross-sectional view of the springs 6 installed onto the center mounting base 5 according to an embodiment of the present invention about section A-A of FIG. 61.

FIG. 63 is a cross-sectional view of the springs 6 installed onto the center mounting base 5 according to an embodiment of the present invention about section B-B of FIG. 60.

FIG. 64 is a cross-sectional view of the springs 6 installed onto the center mounting base 5 according to an embodiment of the present invention about section C-C of FIG. 60.

FIG. 65 is a side view of the end cap according to an embodiment of the present invention. FIG. 66 is a bottom view of the end cap according to an embodiment of the present invention. FIG. 67 is an end view of the end cap according to an embodiment of the present invention. FIG. 68 is bottom perspective view of the end cap according to an embodiment of the present invention. FIG. 69 is a top perspective view of the end cap according to an embodiment of the present invention. FIGS. 65-69 are views illustrating an end cap 4 according to an alternate embodiment of the present application, in which the end cap is comprised of a single unitary piece, as opposed to the previously discussed first and second elements. As illustrated in FIG. 66, the end cap 4 has a locking feature (e.g., locking tabs/locking tap) situated on each side (e.g., on opposing horizontal sides of a bottom interior surface of the end cap and situated along the longitudinal axis that provides a permanent connection between the springs 6 and the end cap 4. The locking feature utilizes protrusions that engage into the spring cut-out located at a side of the springs 6 facing away from the center. That is, each protrusion engages a spring cut-out of a respective spring 6. The spring cut-outs are illustrated in FIGS. 59 and 60.

FIG. 66 further illustrates a hole that permits removal and installation of the wiping element 7, which enhances the usability of the wiper blade assembly of the present invention. That is, the hole is sized to allow a user to physically grab the wiping element 7 and to pull the wiping element 7 out from the end cap 4, and also to allow a new wiping element 7 to be inserted through the end cap 4 and through the rest of the blade assembly, including the spoilers 3 and the center mounting base 5. FIG. 68 illustrates a channel that allows the wiping element 7 to pass through the end cap, and is shaped so as to secure the wiping element 7 to the end cap by having a substantially “T” shape, with the top portion of the channel of the end cap 4 retaining/securing the wiping element 7 thereto. FIGS. 68 and 69 illustrate a protrusion that extend away from the end cap 4 to retain the wiping element 7, in order to ensure secure attachment of the wiping element 7 to the wiper blade assembly.

The present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1-20. (canceled)

21. A wiper blade assembly, comprising:
a center mounting base including:
two pockets extending along a length of the center mounting base; and
a gap between the two pockets;
an adapter holder mounted to the center mounting base and including a first recess at a first side of the adapter holder and a second recess at a second side of the adapter holder; and
two springs positioned within the two pockets of the center mounting base.

22. The wiper blade assembly of claim 21, further comprising two spoilers, each spoiler including two pockets receiving the two springs and engaging a respective one of the first recess and the second recess of the adapter holder.

23. The wiper blade assembly of claim 22, further comprising two end caps, each end cap being positioned at a respective end of the wiper blade assembly and engaging the two springs and a respective one of the two spoilers.

24. The wiper blade assembly of claim 23, further comprising a wiping element engaging the center mounting base and provided within the gap between the two pockets of the center mounting base.

25. The wiper blade assembly of claim 22, further comprising two end caps attached to the two spoilers, wherein each end cap includes:
a recess;
a first element engaging the two springs; and
a second element engaging the first element.

26. The wiper blade assembly of claim 25, wherein the first element of each end cap includes two pockets, and
wherein the second element of each end cap includes two cantilevers fixed to the two pockets of a respective one of the first elements.

27. The wiper blade assembly of claim 25, wherein the recess of each end cap has a shape corresponding to an outer shape of the two spoilers.

28. The wiper blade assembly of claim 22, wherein each spoiler is provided with a circular hole extending along an entire length of the spoiler and spaced from the two pockets of the spoiler to improve flexibility of the spoiler and to improve contact of the wiper blade assembly to a windshield.

29. The wiper blade assembly of claim 28, wherein the two pockets of each spoiler have a closed cross-section.

30. The wiper blade assembly of claim 21, wherein the center mounting base includes tabs to secure the center mounting base to a universal adapter holder.

31. A wiper blade assembly, comprising:
a center mounting base including two pockets extending along a length of the center mounting base;
an adapter holder mounted to the center mounting base and configured to receive a wiper arm adapter; and
two springs mounted to the two pockets of the center mounting base and spaced apart from one another.

32. The wiper blade assembly of claim 31, wherein the center mounting base includes tabs to secure the center mounting base to a universal adapter holder.

33. The wiper blade assembly of claim 32, wherein the adapter holder includes a first recess at a first side of the adapter holder and a second recess at a second side of the adapter holder, and
wherein the wiper blade assembly further comprises:
two spoilers, each spoiler including a pocket receiving a respective one of the two springs and engaging a respective one of the first recess and the second recess of the adapter holder.

34. The wiper blade assembly of claim 33, wherein each pocket has a closed cross-section to encompass a respective one of the two springs.

35. The wiper blade assembly of claim 33, further comprising two end caps, each end cap being positioned at a respective end of the wiper blade assembly and receiving the first spring and the second spring and a respective one of the two spoilers.

36. The wiper blade assembly of claim 35, wherein each end cap includes a first element engaging the two springs and a second element engaging the first element.

37. The wiper blade assembly of claim 36, wherein the first element of each end cap includes two pockets, and
wherein the second element of each end cap includes two cantilevers fixed to the two pockets of a respective one of the first elements.

38. The wiper blade assembly of claim 37, wherein the second element of each end cap includes a circular-shape recess engaging a respective one of the two spoilers.

39. The wiper blade assembly of claim 33, wherein the two pockets of each spoiler have a closed cross-section.

40. The wiper blade assembly of claim 31, further comprising a wiping element engaging the center mounting base and provided within a gap between the two pockets of the center mounting base.
